(19) United States
(12) Patent Application Publication
(10) Pub. No.: US 2025/0166119 A1
(43) Pub. Date: May 22, 2025

(54) Three-dimensional (3D) augmentation digital processing method for two-dimensional (2D) images

(71) Applicant: Junyang Zhou, Vancouver (CA)

(72) Inventor: Junyang Zhou, Vancouver (CA)

(21) Appl. No.: 18/841,665

(22) PCT Filed: Feb. 28, 2022
(86) PCT No.: PCT/IB2022/051727

§ 371 Date: Aug. 26, 2024

(51) Int. Cl. G06T 3/40; G06T 7/11

(52) U.S. Cl. CPC G06T 3/40; G06T 7/11

(57) ABSTRACT

This invention belongs to the field of digital image processing. By applying an image processing method, this invention augments the geometric perspective 3D information of 2D images. This method augments the sense of 3D of 2D images when viewing with naked eyes and produces stereoscopic effect.

### TECHNICAL FIELD OF THE INVENTION

This invention belongs to the field of digital image processing. To be precise, this invention augments 3D effects of 2D images using a digital image processing method.

### BACKGROUND OF THE INVENTION

The 3D information of an image includes binocular disparity, the focusing of eyes, convergence, motion parallax, aerial perspective (which causes changes in color and luminance), occlusion of objects, geometric perspective, and more. Among all information mentioned above, binocular disparity is the strongest 3D information. Because of the pupillary distance between a person's eyes, when looking at a scene, the views obtained by each of the eyes are different from each other, and the brain uses this information (binocular disparity) to form a sense of 3D. Most 3D movies, 3D televisions and other 3D display devices achieve 3D effects by making use of binocular disparity. However, when viewing a plane 2D image, eyes focus on pixels on a plane, and the brain knows this is a 2D image on a plane because of binocular disparity. As the strongest 3D information, binocular disparity weakens the 3D effects of other 3D information in 2D images. The aim of this invention is to augment other 3D information to produce and enhance 3D effects when viewing 2D images with naked eyes.

### SUMMARY OF THE INVENTION

Binocular disparity weakens other 3D information in 2D images, and there are methods to generate and augment 3D effects when viewing 2D images on a flat display by augmenting other 3D information of 2D images. It is possible to augment the 3D information of 2D images displayed on traditional devices (e.g. traditional televisions) by adjusting luminance, color, saturation, contrast, and so on, but adjusting these properties does not have a significant effect. Among all 3D information of 2D images, geometric perspective is a very strong and important information. When drawing a picture, making use of geometric perspective is a very effective way to augment 3D effects, and it is important to locate a vanishing point (as shown by FIG. 1) when making use of geometric perspective. Many traditional image processing methods to augment or generate 3D information are complicated. These traditional methods usually take a long time to be processed, so it is more difficult to apply them in real-time. This invention provides a method which sets a vanishing point or vertical vanishing line on the image and augments geometric perspective based on this vanishing point or vertical vanishing line. By applying this method, the sense of 3D of 2D images is augmented.

In the geometric perspective of an image, there can be one or more vanishing points. Setting only one vanishing point can make the image processing easier. The vanishing point can be replaced by a vertical vanishing line, and this can also make the image processing easier. For a 2D image like the one shown in FIG. 2, a vertical vanishing line can be set at the horizontal center of the image, and in this case, the vertical vanishing line is also the center line of the image.

When viewed by people, farther objects are usually smaller in the scene compared to closer objects. The objects near the vertical vanishing line of an image are usually the farthest from the viewer compared to other objects on the image, so the image processing method of this invention makes the horizontal widths of the objects near the vertical vanishing line smaller compared to their original horizontal widths on the image. The objects away from the vertical vanishing line of the image are usually the closest to the viewer compared to other objects on the image, so this invention makes the horizontal widths of the objects away from the vertical vanishing line larger compared to their original horizontal widths on the image. When the vertical vanishing line is also the center line of the image, on the image, the left and right edges of the image are the farthest away from the vertical vanishing line. Therefore, when the vertical vanishing line is also the center line of the image, the image processing method of this invention makes the horizontal widths of objects near the center line of the image smaller compared to their original horizontal widths on the image, and this method makes the horizontal widths of objects near the left and right edges of the image larger compared to their original horizontal widths on the image. This method has two features: 1. Augmenting 3D information of images by setting a vertical vanishing line of geometric perspective. 2. Making the objects near the vertical vanishing line of images visually farther from the viewer, and making the objects away from the vertical vanishing line of images visually closer to the viewer, so the geometric perspective of the processed images is augmented. This invention is applicable and effective to a wide range of scenes and video sources, such as movies, sports shows, TV shows, TV series, fashion shows, and more.

4 examples of this image processing method are shown in FIGS. 3-6 (top view from above the display).

In [0004], [0005], and [0006], an image processing method that sets a vertical vanishing line is introduced, and this method can be extended to set a vanishing point instead of a vertical vanishing line. For example, in FIG. 15, the vanishing point is set to be at the center point c of the image, and the image is divided into 5 sections (d12, d3, d4, d5, d6) to be processed. When setting a vanishing point, this method makes the sections near the vanishing point smaller both horizontally and vertically. For example, in FIG. 15, section d12 contains the vanishing point, so section d12 is processed to be smaller. When setting a vanishing point, this method makes the sections away from the vanishing point larger both horizontally and vertically. For example, in FIG. 15, section d6 is the outmost section and the section farthest from the vanishing point, so section d6 is processed to be larger.

### BRIEF DESCRIPTION OF DRAWINGS

FIG. 1 illustrates a vanishing point.

FIG. 2 provides an example for a rectangular image and its center line. When the image is rectangular and fills up the whole display, the center line of the image is also the center line of the display.

FIGS. 3-6 show 4 examples of this image processing method. FIG. 7 shows the original image before being processed. To make the examples easier to understand, assume the images in FIGS. 3-7 are filling up the whole display. All of FIGS. 3-7 are showing the top view of the display, where the display is facing to the bottom of the Figures, and the viewer is viewing the display from the bottom of the Figures. In all of FIGS. 3-7, C represents the center line of the image, L represents the left edge of the image, and R represents the right edge of the image. Because all of FIGS. 3-7 are showing the top view of the display, FIGS. 3-7 are also showing the top view of the center line C, left edge L, and right edge R, so the three lines C, L, and R are visible as points in FIGS. 3-7.

FIG. 3 shows the 1st example: In FIG. 3, the vertical vanishing line of the image is set to be at the center line C. After being processed, the image is reduced in horizontal size at the regions near the vertical vanishing line, and the image is increased in horizontal size at the regions away from the vertical vanishing line. Because the original image is on the display, after being processed, the regions near the vertical vanishing line (which is at the center line C in FIG. 3) are visually behind the display and farther from the viewer's eyes. Also, because the vertical vanishing line of the image is set to be at the center line C, the left edge L and right edge R are the farthest away from the vertical vanishing line in FIG. 3. Therefore, in FIG. 3, this method makes the horizontal size of the image increases at the regions near the left edge L and the right edge R (which are away from the vertical vanishing line in FIG. 3), so after being processed, these regions near the left and right edges are visually in front of the display and closer to the viewer's eyes. In FIG. 3, when the original image is processed at the horizontal ¼ and ¾ points from the left edge, the horizontal magnification ratio is set to be 1. Therefore, at the horizontal ¼ and ¾ points from the left edge, the horizontal size of the processed image does not change compared to the original horizontal size, and these two points of the image are still visually on the display. In FIG. 3, the processed image has a symmetrical shape, which is visually behind the display at the horizontal center and visually in front of the display at the left and right edges. By contrast, in FIG. 7, the center line C, left edge L, and right edge R are all visually on the display. In FIG. 3, the horizontal magnification ratio decreases linearly from L to C and from R to C, and the horizontal magnification ratio is equal to 1 at the horizontal ¼ and ¾ points from the left edge. In FIG. 3, the value of the horizontal magnification ratio is the largest at L and R, smallest at C.

FIG. 4 shows the 2nd example. In FIG. 4, the vertical vanishing line of the image is set to be at the center line C, and L and R represent the left and right edges of the image. In FIG. 4, the horizontal magnification ratios for all regions of the image are less than or equal to 1.

FIG. 5 shows the 3rd example. In FIG. 5, the vertical vanishing line of the image is set to be at the center line C, and L and R represent the left and right edges of the image. In FIG. 5, the horizontal magnification ratios for all regions of the image are greater than or equal to 1.

FIG. 6 shows the 4th example. In FIG. 6, the processed image is a tilted plane. In FIG. 6, C represents the center line of the image, and L and R represent the left and right edges of the image. In FIG. 6, the vertical vanishing line is not within the image. When the processed image is a tilted plane, in the processed image, one of the left or right edges has the smallest horizontal magnification ratio among the whole image, and the other left or right edge has the biggest horizontal magnification ratio among the whole image.

In each of the 4 examples shown by FIGS. 3-6, it is also possible to set the vertical vanishing line to be not at the center line of the image.

FIG. 8 shows an example of processing 8 sections of an image to augment 3D information. In FIG. 8, the original image is divided into 8 sections of the same horizontal width, but this method can also set some or all sections to have different horizontal widths in the original image, and the number of sections can also be not 8.

FIG. 9 shows an example of processing 8 sections of an image to augment 3D information with one more step compared to FIG. 8, and this additional step is rounding up or rounding down the number of horizontal pixels to an integer when calculating the processed horizontal width of each section.

FIG. 10 shows processing the image when taking photos or recording videos.

FIG. 11 shows processing the image during TV program post production.

FIG. 12 shows processing the image when a TV or set-top box receives the TV program.

FIG. 13 shows processing the image when playing movies.

FIG. 14 shows processing the image for TV programs that are finished products.

FIG. 15 shows how to process the image to augment 3D information by setting a vanishing point, and the image in FIG. 15 fills up the whole display. In FIG. 15, the vanishing point of the image is set to be at the center point c of the image, and the image is divided into 5 sections (d12, d3, d4, d5, d6) to be processed.

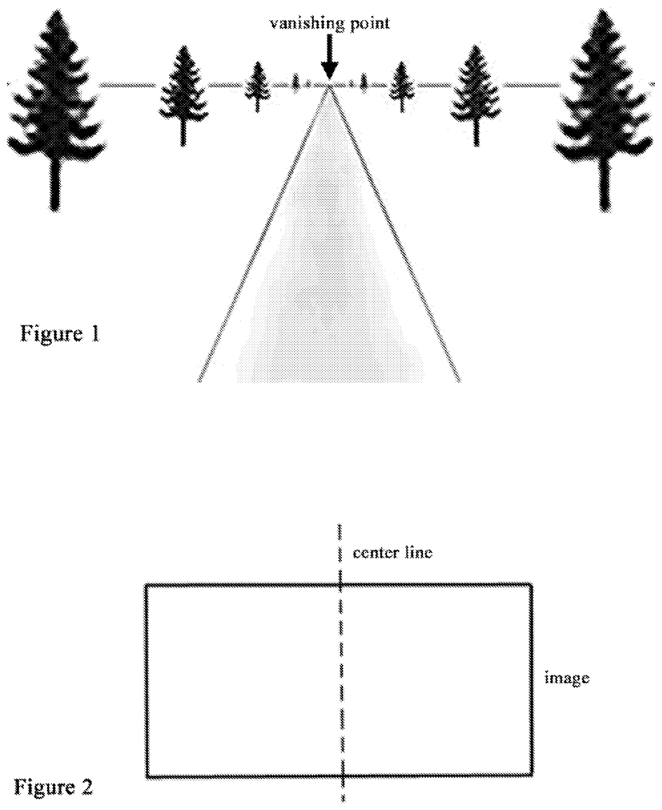

### DESCRIPTION OF EMBODIMENTS

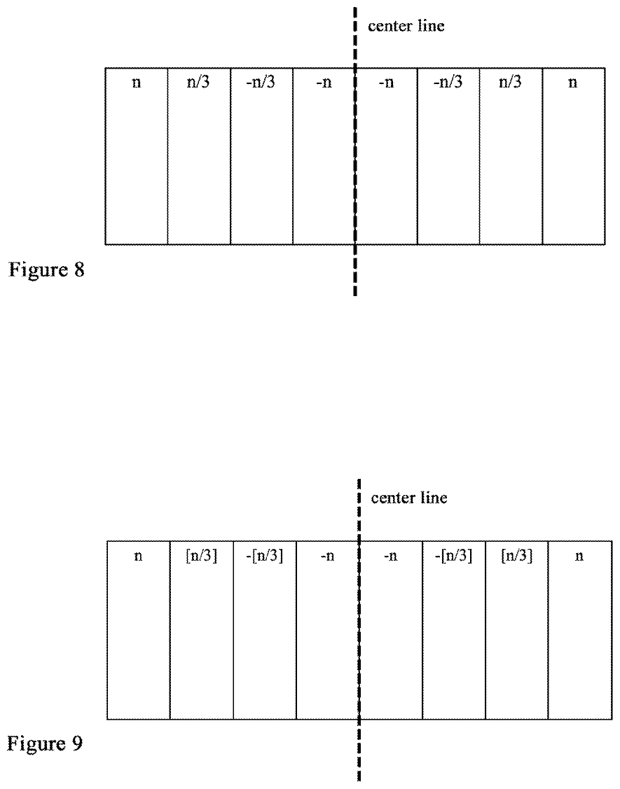

In the example shown in FIG. 8, the original image is horizontally split into 8 sections of the same horizontal width, and each section of the image is processed respectively. The vertical vanishing line of the image is set to be at the center line. Divided by the vertical vanishing line, the 4 sections at left are symmetrical to the 4 sections at right. When being processed, a section can be stretched to be wider, get narrower, or stay the same in terms of horizontal width. This stretching or narrowing process is evenly applied within each section, and each section maintains its information after being processed. In the example shown in FIG. 8, the differences in the number of horizontal pixels expanded or narrowed between any two neighboring sections are all equal (except for the two sections next to the center line because these two center sections have the same horizontal width after being processed). In FIG. 8, there are Width*Height (e.g. 1920*1080) pixels, and n is a positive integer value being used to represent the change in the number of horizontal pixels. The value n/3 shown in the 2nd section from the left means the 2nd section of the original image will have its horizontal width increases by n/3 pixels after being processed, and similarly, any positive value in a section means this section will be processed to be wider, and any negative value in a section means this section will be processed to be narrower. Among all 8 sections in FIG. 8, the 2 sections next to the vertical vanishing line (which is set to be at the center line in this example) have value −n, and this means the horizontal width of each of these two sections will decrease by n pixels. The number of horizontal pixels expanded for each of the 8 sections (from left to right) are n, n/3, −n/3, −n, −n, −n/3, n/3, and n respectively. Divided by the center line, there is a group of 4 sections at left and a group of 4 sections at right. Among each of these two groups of 4 sections, each two neighboring section has the difference in the number of horizontal pixels expanded or narrowed to be 2n/3 pixels, so in FIG. 8, the change of the horizontal magnification ratio is linear from the vertical vanishing line to the left and right edges of the image. In the example shown in FIG. 8, the total number of horizontal pixels expanded among all sections is equal to the total number of horizontal pixels narrowed among all sections, so the total number of horizontal pixels of the entire image does not change after being processed. As shown by FIG. 9, when this method is applied, rounding up or rounding down can be used to convert the processed horizontal width of each section to an integer. In FIG. 9, rounding is applied, and the rounded number of horizontal pixels expanded for each of the sections (from left to right) are n, [n/3], −[n/3], −n, −n, −[n/3], [n/3], and n.

For example, the resolutions of standard-definition television, high-definition television, 4K ultra-high definition television, and 8K ultra-high definition television are 720*576, 1920*1080, 3840*2160, and 7680*4320 respectively. The numbers of horizontal pixels are 720, 1920, 3840, and 7680 respectively. When processing images of different resolutions, this method can apply the same set of horizontal magnification ratios and therefore has the same effect on the output (processed) images. In the example shown in FIG. 8, let k be a preset parameter, and the

value n (being used to represent the change in the number of horizontal pixels) in [0024] can be calculated by having the number of horizontal pixels divided by k. For instance, a high-definition television has 1920 horizontal pixels, and when the image is being processed, n can be calculated by n=1920/k.

In the example shown in FIG. 8, the original image is divided into 8 sections of the same horizontal width, and from the vertical vanishing line (which is set to be at the center line in this example) to the left and right edges of the image, the value of the horizontal magnification ratio increases from smaller than 1 to greater than 1.

When applying this method, the original image can be divided into any number of sections to be processed, and the number of sections can be either odd or even. The vertical vanishing line can be set either at or not at the center line of the image. Prior to being processed, each pair of sections in the original image can have either identical or non-identical horizontal widths, and the arrangement of sections can be either symmetrical or asymmetrical. From the vertical vanishing line to each of the two left or right edges of the image, the change of the horizontal magnification ratio can be either linear or non-linear. After a section is processed, the change of the horizontal width for this section can be as few as 0. The total number of horizontal pixels expanded in all sections can be either equal or not equal to the total number of horizontal pixels narrowed in all sections, and after the entire image is processed, the total horizontal width of the entire image can either change or not change. The original image can be divided into sections in any shapes, and the arrangement of the sections can be horizontal or non-horizontal.

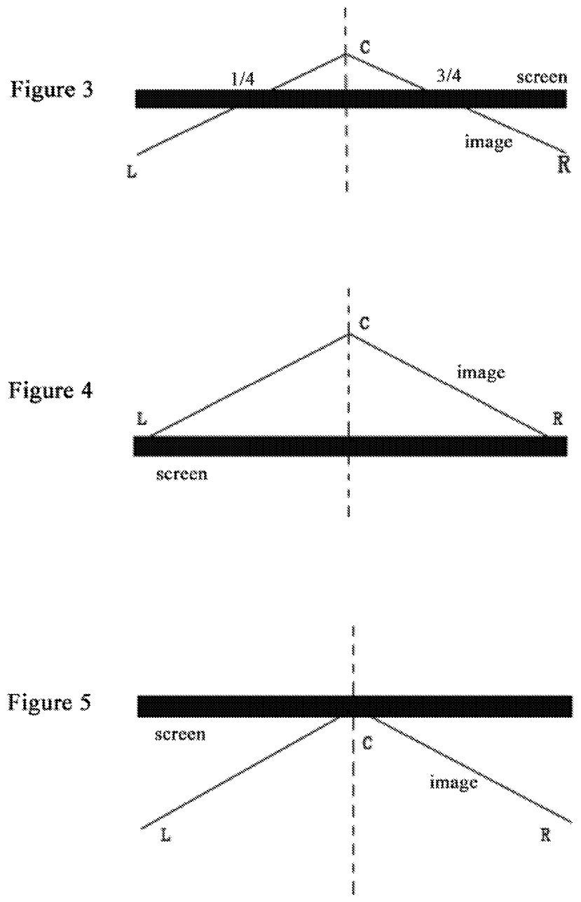

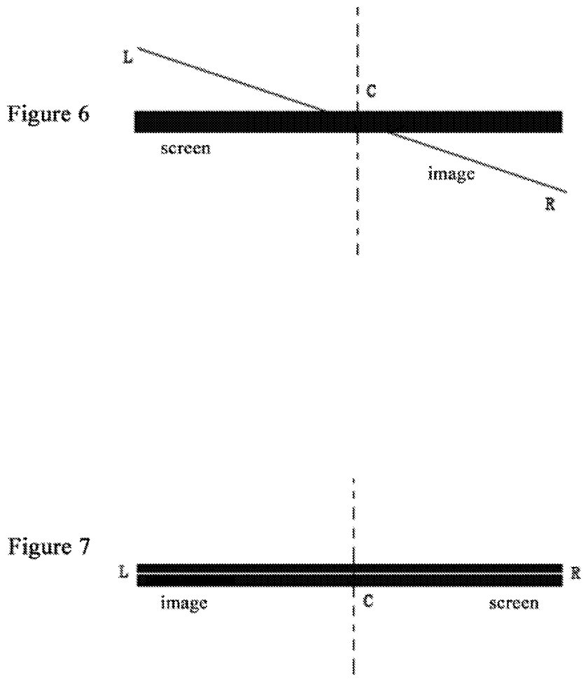

Some examples of different locations and settings of the vertical vanishing line (e.g. whether the vertical vanishing line is at the center line of the image or not) and different settings of horizontal magnification ratios are shown in the 4 examples in FIGS. 3-6.

The vertical processing of geometric perspective can also be added to this method by replacing the vertical vanishing line with a vanishing point. An example of setting a vanishing point is shown in FIG. 15, where the vanishing point is set to be at the center point c of the image. When setting a vanishing point, the original image is also divided into sections to be processed, and the sections can be in any shapes. When setting a vanishing point, this method makes the sections near the vanishing point smaller both horizontally and vertically, and this method makes the sections away from the vanishing point larger both horizontally and vertically. The vanishing point can be set either at or not at the center point of the image.

After applying the image processing method of this invention, if there is a need to adjust the vertical or horizontal size of the processed image, the processed image can be stretched or reduced evenly in size as a whole, and the previously augmented 3D effects will be retained.

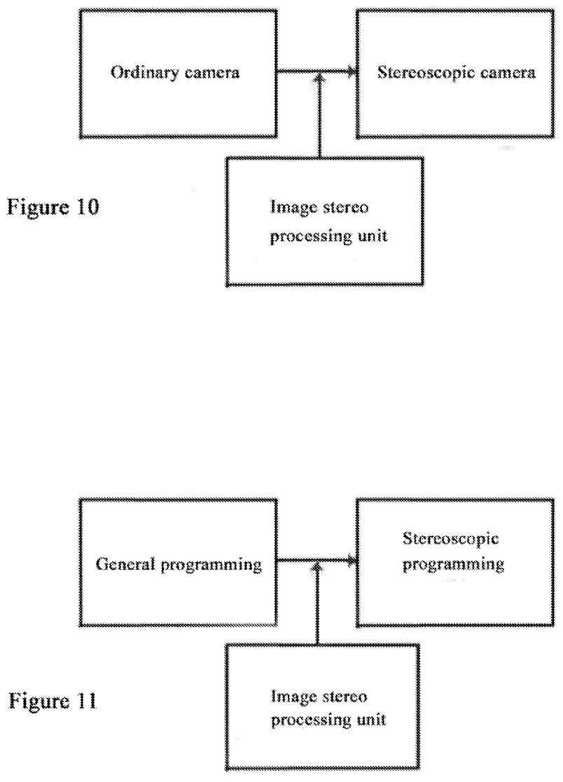

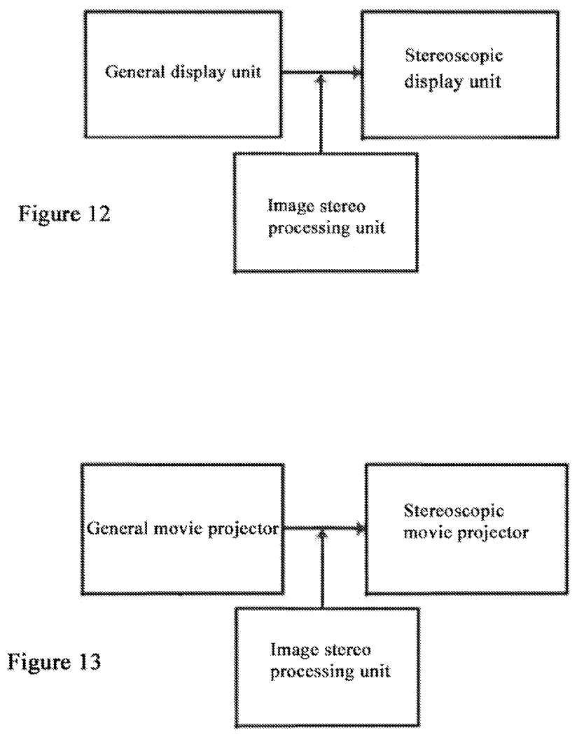

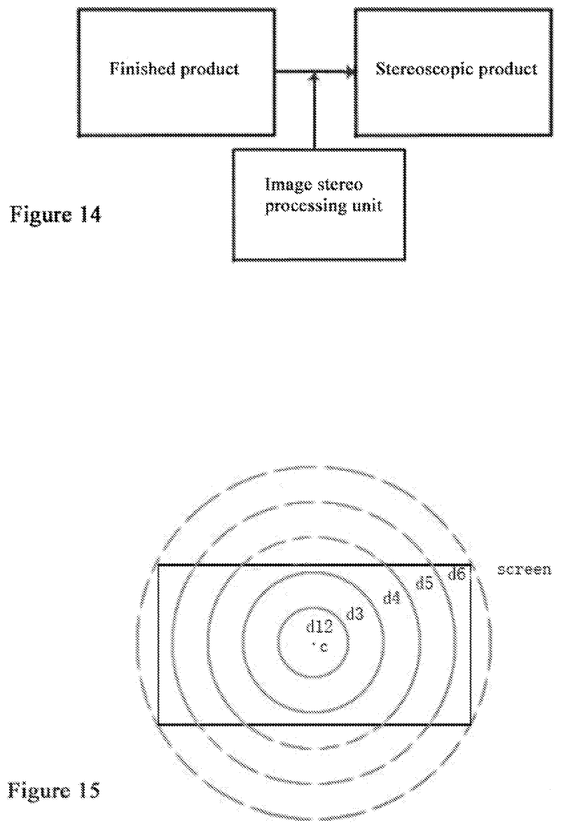

As shown in FIGS. 10-14, this image processing method can be used during the camera shooting process, the intermediate image and video production process, display device, finished images and videos, and more.

1. An image processing method comprising:
locating and setting a vertical vanishing line on the image;
dividing the image into multiple sections;
making the horizontal widths of the sections near the vertical vanishing line smaller; and
making the horizontal widths of the sections away from the vertical vanishing line larger.

2. The image processing method of claim 1, wherein the vertical vanishing line of the image is at the center line of the image.

3. The image processing method of claim 1, wherein the vertical vanishing line of the image is not at the center line of the image.

4. The image processing method of claim 1, wherein all sections have an identical horizontal width in the original image.

5. The image processing method of claim 1, wherein some or all sections have different horizontal widths in the original image.

6. The image processing method of claim 1, wherein the total horizontal width of the image does not change after the image is processed.

7. The image processing method of claim 1, wherein the total horizontal width of the image changes after the image is processed.

8. The image processing method of claim 1, wherein the change of the horizontal magnification ratio is linear from the vertical vanishing line to the left and right edges of the image.

9. The image processing method of claim 1, wherein the change of the horizontal magnification ratio is not linear from the vertical vanishing line to the left and right edges of the image.

10. The image processing method of claim 1, wherein the change of the horizontal magnification ratio is linear from the vertical vanishing line to one of the left or right edges of the image, and the change of the horizontal magnification ratio is not linear from the vertical vanishing line to the other left or right edge of the image.

11. An image processing method comprising:
locating and setting a vanishing point on the image;
dividing the image into multiple sections;
making the sections near the vanishing point smaller both horizontally and vertically; and
making the sections away from the vanishing point larger both horizontally and vertically.

12. The image processing method of claim 11, wherein the vanishing point of the image is at the center point of the image.

13. The image processing method of claim 11, wherein the vanishing point of the image is not at the center point of the image.
